(19) United States
(12) Patent Application Publication
(10) Pub. No.: US 2010/0302772 A1
(43) Pub. Date: Dec. 2, 2010

(54) ADJUSTABLE DISPLAY DEVICE

(76) Inventor: Chi-Hsin LIN, Tamshui Town (TW)

Correspondence Address: HDLS Patent & Trademark Services, P.O. BOX 220746, CHANTILLY, VA, 20153-0746, US

(21) Appl. No.: 12/471,632

(22) Filed: May 26, 2009

(51) Int. Cl. F21V 9/00; F21S 4/00

(52) U.S. Cl. 362/231; 362/249.01; 362/249.02

(57) ABSTRACT

An adjustable display device comprising a top frame, a bottom frame, at least two ropes, vertically spaced at a distance for connecting the top frame and the bottom frame; a plurality of light stripes parallel to and above the ropes. Each light stripe includes a circuit board and illuminating units disposed at a plurality of disposed the circuit board. Each circuit board includes a plurality of line opening, a pull unit disposed one inner side of the top frame and a linkup unit disposed at the other inner side of the top frame. The pull unit includes a paired first box and a first cover, a gearing set connecting to the first box and a first transmission shaft. The linkup unit includes rollers disposed at two sides of the first transmission shaft. When the pull unit is pulled by an external force, the linkup unit rolls to pull up or pull down the display device.

### BACKGROUND OF THE INVENTION

1. Field of the Invention

The present invention relates to a display device. More particularly, it relates to a display device with mechanical and electrical designs for adjusting dimensions of the display device.

2. Description of Prior Art

Light emitting diodes have advantages of low power consumption, high brightness, without display format limitations, robust and suit for producing large displays, and are widely applied to display devices such as traffic signals, indoor and outdoor displays. For example, a full color display for videos can be easily formed by sets of light source modules of light emitting diodes.

The light source modules of light emitting diodes available in the market are categorized into types such as light strings, light stripes, light tiles and light displays. A large display device is formed by a plurality of light source modules of light emitting diodes via specific electrical wiring for displaying videos, stationary pictures or text message. A user may combine a large display with an appropriate audio device to generate a multimedia system for transferring messages or exhibiting commercial products.

However, there are certain limitations in applications of light emitting diode displays such as the dimensions of the light emitting diodes display device fixed and a fixed space occupied. On the other hand, light emitting diodes display can not be easily decomposed and stored after installation completed. The dimensions of light emitting diode displays are not subject to change according to needs.

### SUMMARY OF THE INVENTION

In terms of above mentioned limitations, the prevention provides an adjustable display device for easy storage and flexible adjustment of display dimensions according to immediate needs.

The adjustable display device includes a top frame, a bottom frame, at least two ropes vertically spaced at a distance for connecting the top frame and the bottom frame; a plurality of light stripes arranged parallel to each other and bridged across the ropes, a pull unit and a linkup unit. Each light stripe has a circuit board and a plurality of illuminating units disposed on the circuit board. A plurality of line openings are formed on each circuit board.

The pull unit is disposed at one inner side of the top frame including at least a ball chain, a gear receiving the ball chain, a set of wheel plate disposed at the box, and a first transmission shaft disposed horizontally at the top frame. The linkup unit is disposed at one inner side of the top frame. The linkup unit includes line rollers respectively disposed at two dies of the first transmission shaft. The line roller includes a paired second box, a second cover, a roller wheel disposed inside of the second box, and a roll of adjusting line disposed at peripheral of the roller wheel.

When a user pulls the ball chain, the gear and the wheel plate inside of the pull unit roll accordingly. Consequently, the first transmission shaft drives the roller inside of the link unit leading the adjusting line to be on rolled up or released status so as to pull up or pull down the display device.

The present invention introduces the illuminating units into the design of window shade set such that a general window shade set is transformed into a display device with dimension control. The design according to the present invention overcome the space limitation of the prior art light emitting diodes displays and delivers benefits of easy detachment and storage. The design of the present invention offers conveniences to users to adjust the dimension of a display according to available space on each installing site.

### DETAILED DESCRIPTION OF THE INVENTION

FIG. 1 and FIG. 2 are schematic diagram and lateral view of a preferred embodiment of the adjustable display device according to the present invention. The display device 1 is identical with a common window blade set, where users are free to pull up or down and at the same modifying display area according to individual needs.

The adjustable display device 1 according to the present invention includes a hallow top frame 12, a bottom frame 14 spaced at a distance below the top frame 12, at least two ladder ropes 16 vertically spaced at a distance for connecting the top frame 12 and the bottom frame 14, a plurality of light stripes 18 arranged parallel to each other and bridged across the ladder ropes 16, a pull unit 20 disposed at a inner side of the top frame 12, and a linkup unit 30 disposed at the other inner side of the top frame 12. When the pull unit 20 is pulled by an external force, the linkup unit 30 rolls and drives light stripes 18 to pull up and pull down.

Each light stripe 18 has a circuit board 182 and a plurality of illuminating units 184 disposed at the circuit board 182. In addition, a plurality of line openings 186 are formed on each circuit board 182. Each illuminating unit 184 has light emitting diodes dies emitting red, blue and green color light as the light source. Alternatively, each illuminating unit 184 has dies emitting one or two color light in field embodiments according to the present invention.

Refer to FIG. 1 and FIG. 3, the pull unit 20 includes a first box 22 and a first cover 24 which are a paired set, as well as an internally rotatable gearing set 26. A rod receiver 222 is formed on one side of the first box 22 and a through hole 242 is formed on the first cover 24.

The gearing set 26 has a ball chain 262, a gear 264, a wheel plate 266 to receive the ball chain 262 of the gear 264, and a first transmission shaft 28. The ball chain 262 includes a plurality of balls in series. One end of the gear 264 has depression 2642 to rotatably engage with the rod receiver 222. The peripheral of the gear 264 has a plurality of gear concaves 2646 to receive the balls of the ball chain 262 so that the ball chain 262 drive the gear 264 to roll along the pulling movement. A rectangular protrude piece 2644 is disposed at the other side of the gear 264. The wheel plate 266 is generally a cylinder rotatably passing through the through hole 242 of the first cover 24. A rectangular wheel receiver 2662 is formed on one end of the wheel plate 266 passing through the cylinder. One end of the rectangular wheel receiver 2662 is provided for receiving the rectangular protrude piece 2644 of the gear 264. The first transmission shaft 32 is a long cubic and one end of the first transmission shaft 32 is connected to other end of the rectangular wheel receiver 2662 of the wheel plate 266 mentioned above.

Refer to FIG. 1 and FIG. 4, the linkup unit 30 includes line rollers 32 disposed at two sides of the first transmission shaft 28. The line roller 32 includes a paired second box 322 and a second cover 324 respectively having corresponding opening sets of a upper opening set 320a and a lower opening set 320b disposed at the roller wheel 326, and a roll of adjusting line 328 disposed at peripheral of the roller wheel 326. The roller wheel 326 is formed by an outer circular wheel 3262 and an inner circular rod 3264. The center of the inner circular rod 3264 has a rectangular wheel receiver 3266. The other end of the first transmission shaft 28 disposed passing through the lower opening 320b of the line roller 32 and the rectangular wheel receiver 3266. The adjusting line 328 extended downwards from the roller wheel 326 passing through the top frame 12 and the line openings 186 of the light stripes 18, and connected to the upper surface of the bottom frame 14.

When users pull the ball chain 262, the gear 264 drives the wheel plate 266 to roll. Following that, the first transmission shaft 28 drives the roller wheel 326 of two line rollers 32 to rotate respectively in order to pull up or pull down the adjusting line 328. When the adjusting line 328 is pulled up by the roller wheel 326, the bottom frame 14 is moving pushing the light stripes 18 going upwards to pull up the display device 1. When the roller wheel 326 pull down the adjusting line 328, the light stripes 18 is accordingly expanded.

Refer to FIG. 1, an adjustable display device further includes a light stripe slope tuning device 40 disposed inside of the top frame 12. The light stripe slope tuning device 40 includes a gear rod 42 having axis vertically disposed, a gear wheel 44 having axis horizontally disposed engaging with the gear rod 42, a tuning rod 46 extended downwards from the gear rod 42 protruding downwards through the top frame 12 for offering user control, a second transmission shaft 48 horizontally passing through the upper opening 320a of the two line rollers 32 disposed inside of the top frame 12 connected to the gear wheel 44. The upper ends of the ropes 16 respectively connect to the second transmission shaft 48.

When users roll the tuning rod 46, the gear rod 42 drive the gear wheel 44 to rotate the second transmission shaft 48 and accordingly the ropes 16 are rotated to trigger the light stripes 18 to rotate along the long axis clockwise or counter clockwise. Following that, the surface having the illuminating units 184 is turned upwards or downwards so that the display device face inside or outside of a shop to display messages and pictures to customers inside and outside of the shop.

It should be noted that the above mentioned pull unit 20, the linkup unit 30, and the light stripe slope tuning device 40 can be implemented by prior art techniques and not limited to the preferred embodiment described above.

Alternatively, as shown in the FIG. 1 and FIG. 5, the display device of the present invention further includes a power 50 and a control unit 60. The power 50 and the control unit 60 are both disposed inside of the top frame 12. One end of the control unit 60 connects to the power 50, and the other end of the control unit 60 electrically connects to the illuminating unit 184 of the light stripes 18 respectively via at least a power wire 52 and a signal wire 62. The power 50 and the control unit 60 are configured to offer required power and display signals to the illuminating units 184 on the light stripes 18. As shown in FIG. 5a, the control unit 60 is electrically connected in parallel to the light stripes 18. The power and control signals to light stripe have no interferences on each other.

Furthermore, refer to FIG. 5b, the control unit 60 can also be electrically connected to the light stripes 18 in series. The power and control signals to the light stripes 18 then are transmitted in series along the light stripes 18.

FIG. 6a is one pattern to implement wiring of the power wires 52, the signal control lines 62 and the light stripes 18, where mainly the power wires 52 and the signal wires 62 pass through the line openings 184 identical the means configuring adjusting line 328. The power wires 52 and the signal wires 62 are connected to the circuit boards 182 of light stripes 18 on one surface of light stripes 18. The power and control signals are transmitted to each illuminating unit 184 via the circuit boards 182. The light stripes 18 may be interconnected in series or in parallel.

FIG. 6b is the other pattern to implement wiring connecting the power wires 52, the signal control lines 62 and the light stripes 18 of the display device. The wiring location of the power wires 52 and the signal wires 62 following the wiring configuration of the ropes 16. One surface of the light stripes 18 is connected to each circuit board 182. The power and control signals are transmitted to each illuminating unit 184 via circuit boards 182. The light stripes 18 may be interconnected in series or in parallel.

In conclusion, the display device of present invention provides a plurality of illuminating units 184 disposed on a prior art window blade set to allow the window blade set having the function to display messages or images. Therefore, the display device according to the present invention can be installed on sides of a shop. When the sun light is too strong, the sides of the display device with illuminating units 184 can be rotated to face inner side of the shop blocking the sun light and displaying messages or images to the customers in the shop. When the sun light is weak, the side with the illuminating units 184 can be rotated facing outside of the shop to display messages and pictures to passengers out side of the shop.

In addition, the installation space limitation of prior art display device is overcome by introducing the mechanical design of a window blade set such that the display device is easy to detach and storage. The display device 1 of the present invention may be used as a single display or acts as a display unit for forming a large display without limited by available installation space and allow the display device to be more easily installed and convenient to use.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of an adjustable display device according to the present invention;

FIG. 2 is a lateral view of the adjustable display device according to the present invention;

FIG. 3 is an exploded view of the pull unit of the adjustable display device according to the present invention;

FIG. 4 is an exploded view of the linkup unit of the adjustable display device according to the present invention;

FIG. 5a is a block diagram illustrating a circuit of the adjustable display device according to the present invention;

FIG. 5b is a block diagram illustrating another circuit of the adjustable display device according to the present invention;

FIG. 6a is a diagram illustrating a circuit wiring pattern of the adjustable display device according to the present invention; and

FIG. 6b is a diagram illustrating another circuit wiring pattern of the adjustable display device according to the present invention.

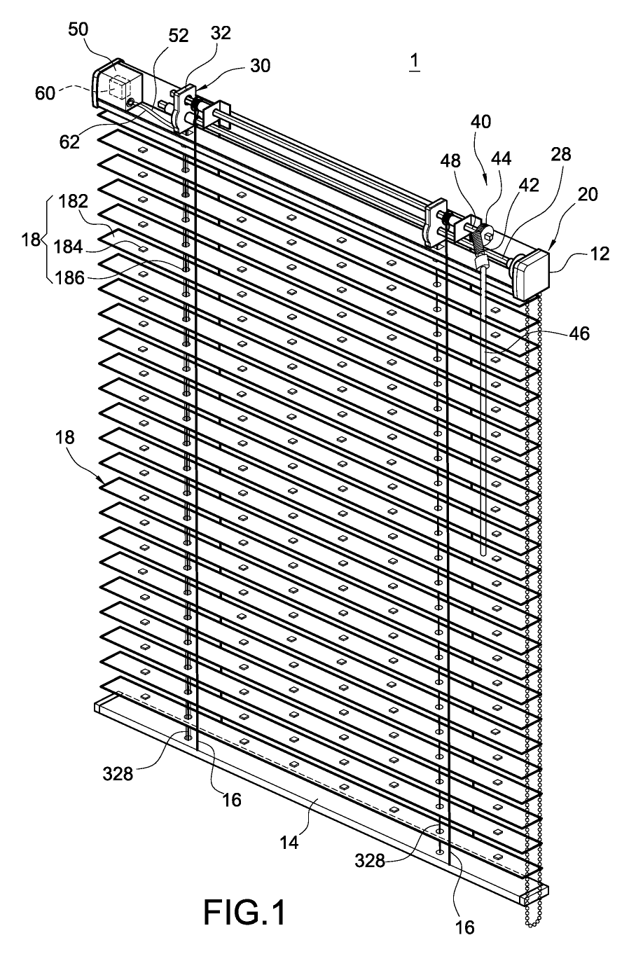

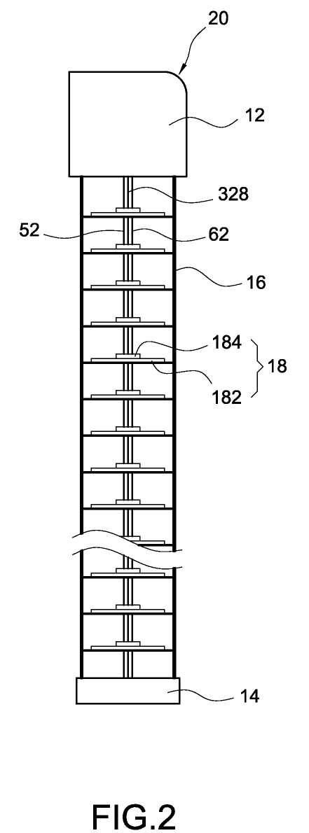

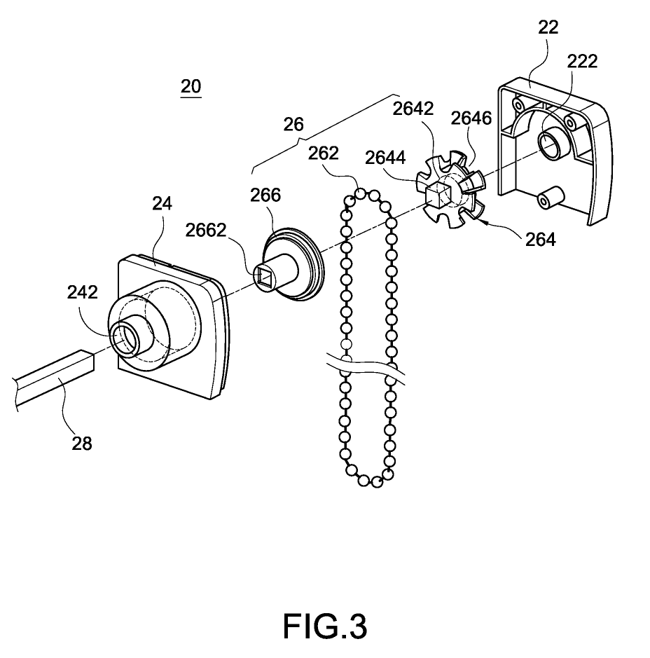

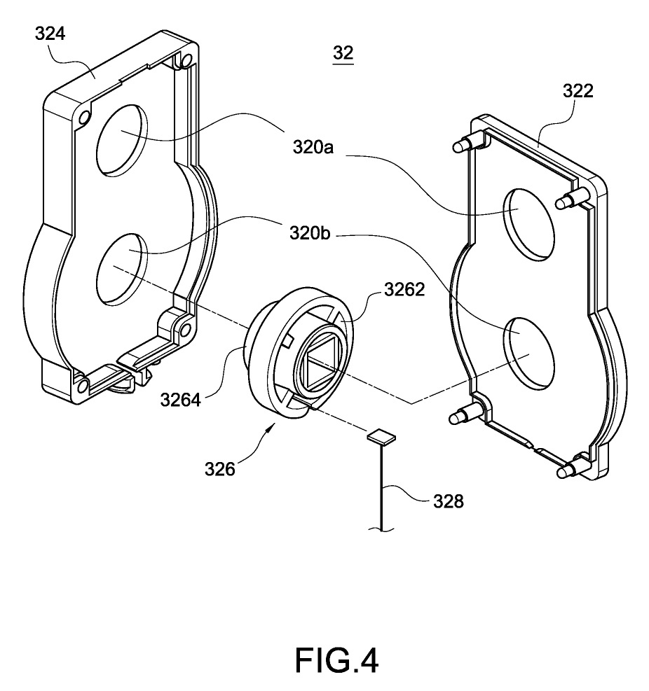

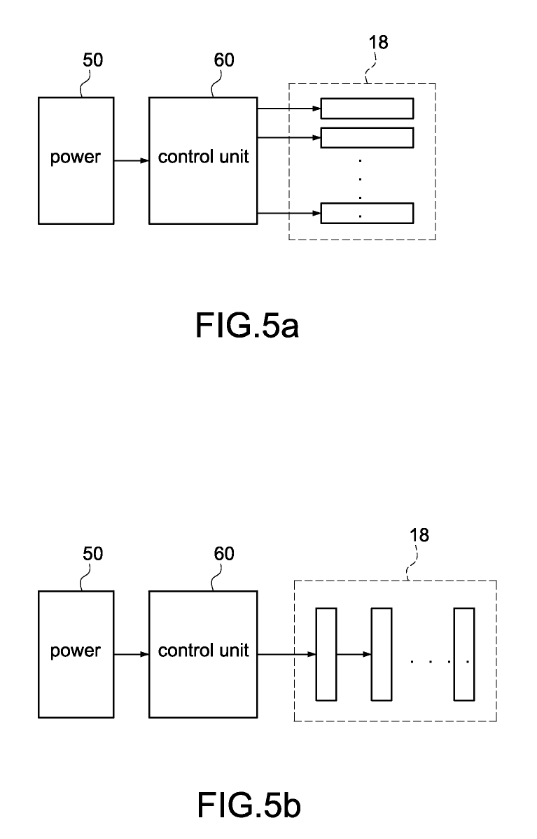

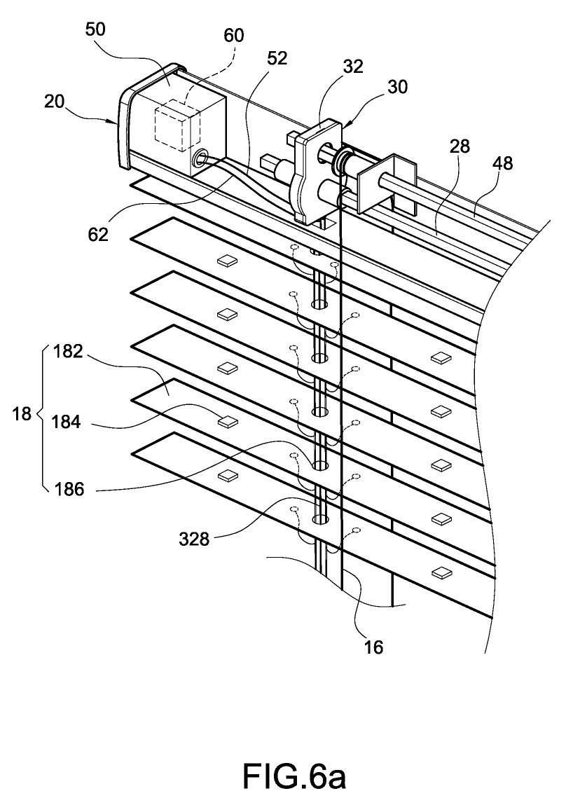

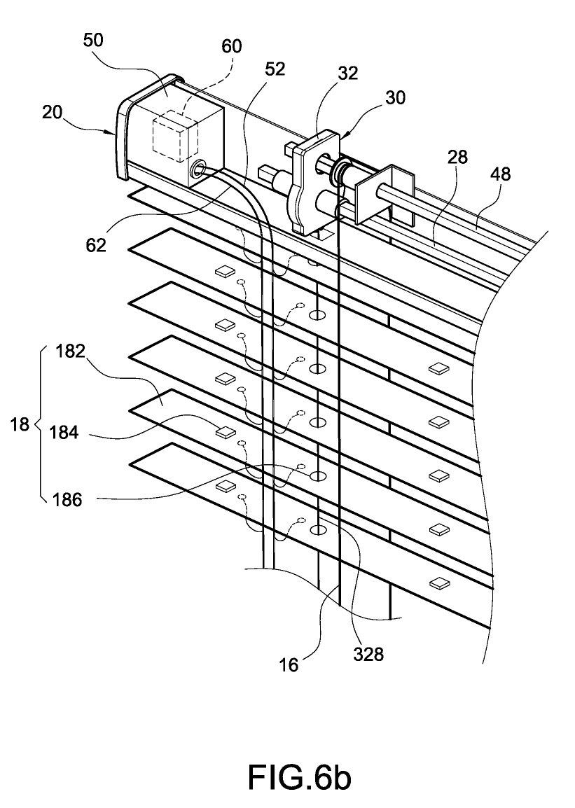

What is claimed is:

1. An adjustable display device comprising:
a top frame;
a bottom frame spaced at a distance below the top frame;
at least two ropes vertically spaced at a distance for connecting the top frame and the bottom frame;
a plurality of light stripes arranged parallel to each other and bridged across the ropes, each of the light stripe comprising a circuit board and a plurality of illuminating units disposed at the circuit board, the circuit board forming a plurality of line openings;
a linkup unit disposed at one inner side of the top frame connected to the bottom frame via the line openings; and
a pull unit disposed at the other inner side of the top frame, the light stripes being pulled up upon applying an external force on the pull unit for driving the linkup unit to pull up the bottom frame towards the top frame.

2. The adjustable display device of claim 1, further comprising a light stripe slope tuning device disposed inside of the top frame, the light stripe slope tuning device comprising:
a gear rod with threads having axis vertically disposed;
a gear wheel engaging with the gear rod having axis horizontally disposed;
a tuning rod extended from the gear rod passing through the top frame for offering user control; and
a second transmission shaft, horizontally disposed inside of top frame and connected to the axis of the gear wheel connecting upper end of the ropes, the gear rod driving the gear wheel and the second transmission shaft to roll and further driving the ropes to rotate for adjusting viewing angle of the light stripes upon a user rolling the tuning rod.

3. The adjustable display device of claim 2, wherein the pull unit comprises a paired first box and a first cover, a internally rotatable gearing set, the gearing set at least comprising a ball chain for driving the gearing set, a gear for receiving the ball chain, a set of wheel plates disposed at the box, and a first transmission shaft.

4. The adjustable display device of claim 2, wherein the linkup unit comprising line rollers respectively disposed at two sides of the the transmission shafts, each the line roller comprising a paired second box and a second cover, a roller wheel located inside of the box, and a roll of adjusting line disposed at the peripheral of the roller wheel.

5. The adjustable display device of claim 1 further comprising:
a power disposed inside of the top frame and configured with at least a power wire;
a control unit disposed inside of the top frame, electrically connected to the power, and configured with at least a signal wire;
wherein, the power and the control unit are used for offering power and display signals required by the illuminating units of the light stripes.

6. The adjustable display device of claim 3, wherein a plurality of gear concaves are disposed at peripheral of the gear for receiving the ball chain and a rectangular protrude piece is extended at one lateral side of the gear to receive the wheel receiver, and the other lateral side is connected to the first box.

7. The adjustable display device of claim 3, wherein the wheel plate has rectangular wheel receiver with through hole, one end of the wheel plate receives the rectangular protrude piece of the gear, and the other end receives the first transmission shaft.

8. The adjustable display device of claim 4, wherein the roller wheel is formed by an outer circular wheel having a release and a inner circular rod, the center of the inner circular rod has a rectangular wheel receiver for allowing the first transmission shaft to pass through.

9. The adjustable display device of claim 4, wherein the second box and second cover respectively have two corresponding upper and lower openings opposite each other for allowing the second transmission shaft and the roller wheel the to pass through.

10. The adjustable display device of claim 5, wherein the ropes are power wires for transmitting power and signal wires for transmitting signals.

11. The adjustable display device of claim 5, wherein the power wires and the signal wires pass through the openings on light stripes, and are electrically connected to the light stripes.

12. The adjustable display device of claim 5, wherein power and signals among the light stripe and light stripes are connected in series.

13. The adjustable display device of claim 5, wherein power and signals among the light stripe and light stripes are connected in parallel.

14. The adjustable display device of claim 1, wherein the illuminating units comprises a light source of light emitting diodes having at least one color light.

15. The adjustable display device of claim 1, wherein the illuminating units are light emitting diodes emitting red, blue and green lights.
